(19) United States
(12) Patent Application Publication
(10) Pub. No.: US 2012/0143674 A1
(43) Pub. Date: Jun. 7, 2012

(54) PERFORMANCE-BASED ADVERTISING PLATFORM THAT TRANSFORMS ADVERTISER SELF-INTEREST INTO A SOCIAL BENEFIT

(75) Inventors: Jay Brian Ziskrout, South Duxbury, VT (US); Tammo Mueller, Tarrytown, NY (US)

(73) Assignee: DYMPOL, INC., Waitsfield, VT (US)

(21) Appl. No.: 13/371,598

(22) Filed: Feb. 13, 2012

Related U.S. Application Data
(63) Continuation-in-part of application No. 12/562,838, filed on Sep. 18, 2009.
(60) Provisional application No. 61/098,099, filed on Sep. 18, 2008.

(51) Int. Cl. G06Q 30/02

(52) U.S. Cl. 705/14.43

(57) ABSTRACT

Embodiments of the system as described herein provide advertisers the ability to participate in charitable giving/cause marketing campaigns while tying costs to measurable performance. Embodiments of the system are configured to match advertisers with Influencers and causes based upon the evaluation of multilateral campaign criteria, providing the ability for advertisers to link their goods and services to one or more Influencers and/or charitable causes.

### CROSS-REFERENCE TO RELATED APPLICATIONS

This application claims the benefit of the following provisional applications, each of which is hereby incorporated by reference in its entirety: U.S. Pat. App. No. 61/098,099 filed on Sep. 18, 2008 and entitled “PRICE AND INTERACTIVE ADVERTISING OPTIMIZATION USING REAL-TIME DIRECT CONSUMER TRANSACTIONS AND COMPETITIVE SPONSOR BIDDING.”

The present application is a continuation-in-part of U.S. patent application Ser. No. 12/562,838, entitled, “SPONSORSHIP OF INDIVIDUAL, DIRECT-TO-CONSUMER TRANSACTIONS,” which claims priority to the above referenced provisional patent application (U.S. Pat. App. No. 61/098,099), filed Sep. 18, 2009. The content of the aforementioned application is hereby incorporated by reference into the present disclosure.

### BACKGROUND

A digital good or service can be supplied in substantially unlimited supply and, as a corollary, at substantially no marginal cost. Therefore, in order to provide an economic incentive to suppliers of digital goods or services, value-based pricing (as opposed to supply-and-demand pricing) must be applied in determining the price of digital goods and services.

In order to apply value-based pricing, one must know or determine a good or service's value to a consumer (or, at least, to a cohort of consumers).

Split testing provides a way of determining the value. Here, a set of consumers is randomly split into groups. Consumers in one group are presented with a first price for a digital good while consumers in a second group are presented with a second price. If one group shows a greater propensity to buy the digital good then, all else being equal or accounted for, one can draw an inference about the value of the good in the eyes of the consumers. With that, a vendor can pick a price for the digital good that maximizes gross sales.

A problem with split testing in this context is that some consumers are offered a lower price than others. Once consumers get wise to this, it may anger the consumers who are offered the higher price.

Instead of split testing, a vendor can vary the price of a digital good for all consumers over time, watching to see if demand changes with the price changes. The trouble with this approach is that external factors (e.g., a promotional blitz, a holiday, a website outage, consumers waiting for the next change, temporal gaming, speed with which demand changes, etc.) may vary from time period to time period. As a result, differences in sales volume or sales conversion rates from one time period to another are likely not a function of the price alone (if at all).

In another approach, a vendor might accept a coupon for a digital good. A difference in sales volume during a coupon campaign might provide some insight into consumers' price sensitivity with respect to a digital good. Unfortunately, it has been shown that a coupon's value may provide a price signal to a consumer, as discussed for example in Raghubir, Priya (1998), “Coupon Value: A Signal for Price?” Journal of Marketing Research, Vol. 35(3), August, 316-324. In other words, the value of the digital good can, in the consumer's mind, be influenced by the value of the coupon itself. This confuses attempts to determine how the consumer values the digital good in the absence of the coupon.

Once a suitable approach is found to determine the value of a good or service, one might choose to instantiate the approach in an Internet-based system or method. The Internet and other digital communications networks allow a substantially unlimited number of consumers to participate. Thus, whatever approach is employed, it should enable Internet-scale embodiments with large numbers of users, workload bursts and spikes, and so on.

There remains a need for scalable, consumer-friendly approaches to value-based pricing of digital goods and services.

### SUMMARY

Embodiments of the system as described herein provide consumer-friendly, value-based pricing of digital goods. As a result, wholesale prices, retail prices, operator profitability, and interactive brand advertising campaigns can be optimized.

In one aspect, a computer-implemented method that performs a price and discount optimization by synthesizing sales data with low-cost and minimum-risk exploration to determine on-the-fly regret-minimizing prices that is disclosed herein includes retrieving, from a data store, at an optimization application server that is operatively coupled to the data store, a sales portfolio for an item, the sales portfolio including a plurality of raw purchase data; converting, at the optimization application server, the sales portfolio for the item into a signature vector that represents sales performance of the item in a variety of market sectors; retrieving, from the data store, at the optimization application server, present and historic signature vectors; aggregating, at the optimization application server, the present and historic signature vectors into aggregate signature vectors; clustering, at the optimization application server, the aggregate signature vectors into template signature vectors that represent statistically different item types; matching, at the optimization application server, the signature vector of the item to the nearest one of the template signature vectors; calculating, at the optimization application server, a lookup table for the nearest one of the template signature vectors, the lookup table computed via experimentation on a subset of all items aggregated over time; selecting, at the optimization application server, an optimal price for the item from the lookup table; transmitting, from the optimization application server to a web application server, the optimal price for the item; receiving, at the web application server from the optimization application server, the optimal price for the item; transmitting, from the web application server, to an application displaying a virtual storefront interface at a remote computer, via a first network connection, the optimal price for the item; receiving, at the web application server, from a second network connection to the application displaying the virtual storefront interface at the remote computer, a raw purchase datum indicating a purchase of the item by a user; storing, to the data store, the raw purchase datum; charging, at a business application server, a fee to an account of a brand marketer or marketer of a digital product or service, the fee attributed to the purchase of the item by the user; calculating, at a business application server, a difference between the optimal price for the item and a retail price for the item; and accumulating, at the business application server, the difference in a rebate account of the user.

The first network connection may be the second network connection.

The application displaying the virtual storefront interface at the remote computer may include a web browser plug-in.

The business application server may be the web application server.

The computer-implemented method that performs a price and discount optimization by synthesizing sales data with low-cost and minimum-risk exploration to determine on-the-fly regret-minimizing prices may include receiving, at the web application server, from a third network connection to an application on a remote computer, a rebate redemption request of the user; and issuing a redemption payment to the user, wherein the issuing of the rebate comprises deducting, at the business application server, an amount of the rebate redemption from the rebate account of the user.

The computer-implemented method that performs a price and discount optimization by synthesizing sales data with low-cost and minimum-risk exploration to determine on-the-fly regret-minimizing prices may include transmitting, to the remote computer, the item.

The computer-implemented method that performs a price and discount optimization by synthesizing sales data with low-cost and minimum-risk exploration to determine on-the-fly regret-minimizing prices may include receiving, from a remote server, a plurality of raw purchase data indicating sales by the third party; and storing, to the data store, the plurality of raw purchase data.

The computer-implemented method that performs a price and discount optimization by synthesizing sales data with low-cost and minimum-risk exploration to determine on-the-fly regret-minimizing prices may include retrieving, from the data store, a plurality of raw purchase data; and transmitting, to a remote server, the plurality of raw purchase data.

The computer-implemented method that performs a price and discount optimization by synthesizing sales data with low-cost and minimum-risk exploration to determine on-the-fly regret-minimizing prices may include receiving, from a remote server, a result of a query; and transmitting, to a the remote server, in response to the result of the query, instructions to change an online advertising program.

The result of the query may be a result of a continuous query.

In one aspect, a system that performs a price and discount optimization by synthesizing sales data with low-cost and minimum-risk exploration to determine on-the-fly regret-minimizing prices that is disclosed herein includes a data store that stores a sales portfolio for an item, present and historic signature vectors, wherein the sales portfolio including a plurality of raw purchase data; an optimization application server operatively coupled to the data store; a web application server operatively coupled to both the optimization application server and the data store; a business application server operatively coupled to the data store; a first memory in the optimization application server, the first memory containing computer-executable code that, when processed by the optimization application server, performs steps comprising: converting the sales portfolio for the item into a signature vector that represents sales performance of the item in a variety of market sectors; aggregating the present and historic signature vectors into aggregate signature vectors; clustering the aggregate signature vectors into template signature vectors that represent statistically different item types; matching the signature vector of the item to the nearest one of the template signature vectors; calculating a lookup table for the nearest one of the template signature vectors, the lookup table computed via experimentation on a subset of all items aggregated over time; selecting an optimal price for the item from the lookup table; and transmitting the optimal price for the item to a web application server; a second memory in the web application server, the second memory containing computer-executable code that, when processed by the web application server, performs steps comprising: receiving the optimal price for the item from the optimization application server; transmitting, to an application displaying a virtual storefront interface at a remote computer, the optimal price for the item; receiving, from the application displaying the virtual storefront interface at the remote computer, a raw purchase datum indicating a purchase of the item by a user; and storing, to the data store, the raw purchase datum; a third memory in the business application server, the third memory containing computer-executable code that, when processed by the business application server, performs steps comprising: charging a fee to an account of a brand marketer, the fee attributed to the purchase of the item by the user; calculating a difference between the optimal price for the item and a retail price for the item; and accumulating the difference in a rebate account of the user.

The first network connection may be the second network connection.

The application displaying the virtual storefront interface at the remote computer may include a web browser plug-in.

The business application server may be the web application server

The second memory in the web application server may further contain computer-executable code that, when processed by the web application server, performs steps comprising receiving, from a third network connection to an application on the remote computer, a rebate redemption request of the user; and issuing a redemption payment to the user, wherein the issuing of the rebate comprises deducting an amount of the rebate redemption from the rebate account of the user.

The computer-implemented method that performs a price and discount optimization by synthesizing sales data with low-cost and minimum-risk exploration to determine on-the-fly regret-minimizing prices may include an item transfer server operatively coupled to the remote computer; and a fourth memory in the item transfer server, the fourth memory containing computer-executable code that, when processed by the item transfer server, performs steps comprising: transmitting, to the remote computer, the item.

The web application server may be operatively coupled to a remote server, and wherein the second memory in the web application server further contains computer-executable code that, when processed by the web application server, performs steps comprising receiving, from the remote server, a plurality of raw purchase data indicating sales by the third party; and storing, to the data store, the plurality of raw purchase data.

The web application server may be operatively coupled to a remote server, and wherein the second memory in the web application server further contains computer-executable code that, when processed by the web application server, performs steps comprising retrieving, from the data store, a plurality of raw purchase data; and transmitting, to the remote server, the plurality of raw purchase data.

The web application server may be operatively coupled to a remote server, and wherein the second memory in the web application server further contains computer-executable code that, when processed by the web application server, performs steps comprising receiving, from the remote server, a result of a query; and transmitting, to the remote server, in response to the result of the query, instructions to change an online advertising program.

The result of the query may be a result of a continuous query.

In one aspect, a web-based system that enables advertisers to participate in charitable giving/cause marketing campaigns while significantly tying cost to measurable performance that is disclosed herein includes a data store that stores an advertising portfolio for an advertiser, wherein the advertising portfolio includes a plurality of data regarding the advertiser, wherein said plurality of data regarding the advertiser includes present and historic signature vectors; an optimization application server operatively coupled to the data store; a web application server operatively coupled to both the optimization application server and the data store; a business application server operatively coupled to the data store; a first memory in the optimization application server, the first memory containing computer-executable code that, when processed by the optimization application server, performs steps comprising: converting the advertiser portfolio for the advertiser into a signature vector that represents performance of the advertiser in a variety of charitable sectors; aggregating the present and historic signature vectors into aggregate signature vectors; clustering the aggregate signature vectors into template signature vectors that represent statistically different advertising types; matching the signature vector of the advertiser to the nearest one of the template signature vectors; calculating a lookup table for the nearest one of the template signature vectors, the lookup table computed via experimentation on a subset of all advertisers aggregated over time; selecting an optimal charitable sector from the lookup table; and transmitting the optimal charitable sector for the advertiser to a web application server; a second memory in the web application server, the second memory containing computer-executable code that, when processed by the web application server, performs steps comprising: receiving the optimal charitable sector for the advertiser from the optimization application server; transmitting, to an application displaying a virtual interface at a remote computer, an association between the advertiser and a charity selected from the optimal charitable sector; receiving, from the application displaying the virtual interface at the remote computer, a donation datum indicating a donation made by a user; and storing, to the data store, the donation datum; a third memory in the business application server, the third memory containing computer-executable code that, when processed by the business application server, performs steps comprising: calculating a reward to be provided from the advertiser to the user for the donation; and distributing said reward to the user.

According to an embodiment of the present invention, the reward to be provided from the advertiser to the user may be based, at least in part, on the magnitude of the donation made by the user.

According to an embodiment of the present invention, the web-based system may be further configured to utilize an Influencer associated with said optimal charitable sector.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a system for value-based pricing.

FIG. 2 depicts a method for value-based pricing.

FIG. 3 depicts a method for value-based pricing in conjunction with issuing a rebate to a user.

FIG. 4 depicts a method for value-based pricing in conjunction with selling and transmitting an item to a user.

FIG. 5 depicts a method for value-based pricing in conjunction with supplemental, raw purchase data and passive media consumption data.

FIG. 6 depicts a method for value-based pricing in conjunction with a multi-campaign marketing organization.

FIG. 7 depicts a method for value-based pricing in conjunction with a search-driven advertising network.

FIG. 8 depicts a user interface for value-based pricing in conjunction with brand promotion.

FIG. 9 depicts an example of a user interface for auction price testing according to one embodiment.

FIG. 10 depicts a process of identifying a price point.

FIG. 11 depicts examples of demand curves.

FIG. 12 depicts examples of revenue curves.

FIG. 13 depicts a user interface for charitable donations associated with an advertiser, in accordance with an embodiment of the present invention.

FIG. 14 depicts a “Social Thanks,” in accordance with an embodiment of the present invention.

### DETAILED DESCRIPTION

Embodiments of the system as described herein provide a third-party system that interfaces with participating retailers; non-participating retailers; service, content, and commodity producers (also referred to as “Rights Holders” and “Wholesalers”); consumers; and advertisers to optimize wholesale prices, retail prices, and interactive brand advertising campaigns, respectively.

Among other things, embodiments can be directed to optimize prices through price exploration with participating retailers and discount exploration through non-participating retailers.

In currently preferred embodiments, a goal of optimizing prices includes maximizing both sales volume and operator profit. Therefore, when price optimization is still in progress, an “optimal price” is an exploratory price chosen in pursuit of determining a sales-volume-maximizing price, a operator-profit-maximizing price, a campaign-effectiveness-maximizing price, or the like. In other cases, when price optimization is already achieved, the optimal price is the sales-volume maximizing price, the operator-profit-maximizing price, the campaign-effectiveness-maximizing price, and so on.

In alternate embodiments, the goal of optimizing prices may include maximizing gross sales, net sales, or any of a host of metrics that one will readily appreciate.

For example and without limitation, a goal of optimizing prices could include optimizing a measurable result for a sponsor (i.e., maximize customer engagement, brand recall, event attendance, sign-ups, opt-ins, or the like), for an advertiser (i.e., maximize sales volume, revenue, margin, or the like), for a service provider that operates an embodiment of the invention (i.e., maximize gross revenue, operating margin, market penetration, and so on).

Regardless of the goal of optimizing prices, the act of optimizing prices may take a variety of forms. In currently preferred embodiments, the act of optimizing prices includes first selecting an optimal discount for an item and then producing the optimal price by subtracting the optimal discount from a retail price of the item. Thus, when price optimization is still in progress, the optimal discount is an exploratory discount, one chosen in pursuit of determining an optimal price that maximizes a metric. In alternate embodiments, however, the act of optimizing prices may include selecting the optimal price directly, without employing a function of a discount and a retail price. One will appreciate that the retail price could be a prevailing retail price, a manufacturer's suggested retail price, or the like.

For the purpose of illustration, some of this description is directed toward embodiments where the goal of optimizing prices is to maximize revenue to a content provider. However, it should be appreciated that in general the act of optimizing prices can be directed to any and all of a wide variety of goals. These goals, some examples of which are provided above and elsewhere, will be readily appreciated and are intended to fall within the scope of this disclosure. Likewise, the scope of this disclosure also includes embodiments that are directed to any and all of the wide variety of goals.

In some embodiments, price optimization for products sold through participating retailers are achieved through integration with the retail service of a dynamic pricing subsystem, an auction subsystem, or a combination thereof.

In some embodiments, price exploration through the use of variable discounts for products sold through non-participating retailers may be achieved through a proprietary application that overlays discounted prices on top of retailers' online storefronts or on third party websites that incorporate content and the transaction fulfillment capabilities of such non-participating retailers (“Virtual Storefronts”). The discounts relating to testing with non-participating retailers can optionally be subsidized through an advertising subsystem that includes an auction subsystem in which advertisers may bid to be associated with particular consumer transaction discounts. The system can be directed to optimize prices, advertising campaigns, or the cost of conducting price testing (thus, maximizing the profitability of the operator of the embodiments) from data acquisition from across all subsystems.

The techniques and principles described herein can be applied to any type of product or service. For illustrative purposes, however, embodiments are primarily described in terms of online digital music markets.

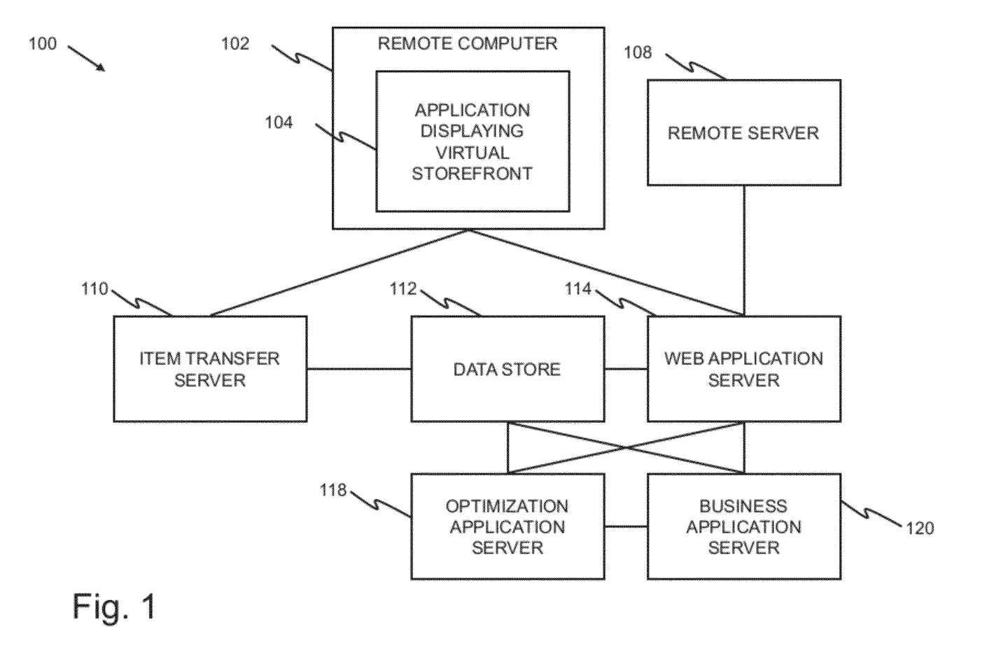

FIG. 1 depicts a system for value-based pricing. The system 100 includes a remote computer 102, an application displaying a virtual storefront 104, a remote server 108, an item transfer server 110, a data store 112, a web application server 114, an optimization application server 118, and a business application server 120.

The lines that connect elements of the system 100 represent operative couplings through which information may be transferred among the connected elements. Such operative couplings can include digital network connections (including without limitation personal-, local-, metropolitan-, or wide area networks); inter-process communications channels such as pipes, message queues, shared memory, or the like; and so on. In embodiments, any and all of the elements may reside within a single computer, multiple computers, a computing cloud, or the like. In embodiments, any and all of the elements may reside in a single software application, multiple software applications, multiple software services, and so on. A variety of such embodiments will be readily appreciated.

The remote computer 102 may include any and all forms of computing device providing a user interface through which a user can view an item for sale (including both a retail and discounted price thereof) and select the item. For example and without limitation, in embodiments the remote computer 102 may be a personal computer, a palmtop computer, a personal digital assistant, a smart phone, and so on. The remote computer 102 is operatively coupled to the item transfer server 110 and the web application server 114.

The application displaying the virtual storefront 104 may include of any software application capable of rendering a virtual storefront user interface and receiving input via said interface. For example and without limitation, in embodiments the application displaying the virtual storefront interface 104 may include a web browser, a web browser with a suitable plug-in installed, a standalone application, a terminal application, and so on. The application displaying the virtual storefront 104 may communicate with the item transfer server 110 and the web application server 114 via the operative couplings to the remote computer 102.

The remote server 108 may include any form of computing device capable of communicating with the web application server 114. For example and without limitation, in embodiments the remote server 108 may be a server computer, a computing cloud, a network-attached storage device, a storage cloud, and so on. The remote server 108 is operatively coupled to the web application server 114.

The item transfer server 110 may include any form of computing device capable of transferring a digital item to the remote computer 102. For example and without limitation, in embodiments the item transfer server 110 includes or is operatively coupled to a digital item storage facility, which containing digital items. From time to time (e.g., after a user has purchased a digital download, in accordance with a subscription service, or the like), the item transfer server 110 may transmit an item (e.g., a digital download, a digital stream, or the like) to the remote computer 102. In embodiments, the transfer occurs via a file transfer protocol, a stream transfer protocol, or the like. A variety of such protocols will be readily appreciated. The item transfer server 110 is operatively coupled to the remote computer 102 and the data store 112.

The data store 112 may include any form of computing device capable of storing information and communicating with other computing devices. For example and without limitation, in embodiments the data store 112 includes a relational database management system, a stream-based database management system, or the like. A variety of suitable database management systems will be readily appreciated. The data store 112 is operatively coupled to the item transfer server 110 and the web application server 114.

The web application server 114 may include any form of computing device capable of hosting a web application. For example and without limitation, in embodiments the web application server 114 includes a web server, a cluster of web servers, a cloud-based web serving service, or the like. Embodiments of the web application server 114 include a web server application and associated software modules. A variety of suitable web server applications (such as Apache) and associated software modules (such as a Personal Home Page (PHP) interpreter) will be readily appreciated. In any case, the web application server 114 may serve web pages or the like to the application displaying the virtual storefront 104, the web pages describing or specifying aspects of the virtual storefront such as item name, retail price of item, discount price of item, logo of sponsoring marketer, style sheets, hypertext, and so on. Methods of the web application server 114 are described in greater detail hereinafter. The web application server 114 is operatively coupled to the remote server 108, the data store 112, the optimization application server 118, and the business application server 120.

The optimization application server 118 may include any form of computing device capable of receiving and responding to requests from the web application server 114, retrieving and storing information to the data store 112, and communicating with the business application server 120. For example and without limitation, in embodiments the optimization application server 118 includes a compute server, a compute cluster, a compute cloud, or the like. Methods of the optimization application server 118 are described in detail hereinafter. The optimization application server 118 is operatively coupled to the data store 112, the web application server 114, and the business application server 120.

The business application server 120 may include any form of computing device capable of receiving and responding to requests form the web application server 114, retrieving and storing information to the data store 112, and communicating with the optimization application server 118. For example and without limitation, in embodiments the business application server 120 includes a compute server, a compute cluster, a compute cloud, or the like. Methods of the business application server 120 are described in detail hereinafter. The business application server 120 is operatively coupled to the data store 112, the web application server 114, and the optimization application server 118.

Embodiments of the system 100 can be employed to apply price optimizations to the sales of services and goods (including digital downloads). Such embodiments employ pricing algorithms that interface with a network of rights holders and retailers to use a broad range of sales and pricing data in order to establish an optimal price. To do so, the system 100 engages the participation of consumers to provide a seamless price testing experience and transaction tracking mechanism that is fully integrated into the work flow of existing third party online sales channels (“Retailers”) or instances of Virtual Storefronts without the need of awareness, cooperation or permission on the part of such Retailers.

In embodiments of the system 100, a collection of subsystems may be used either independently or in combination with each other or with other subsystems, including:

In embodiments the data store 112 may include a Demand Database Subsystem that tracks sales of various commodities at various prices and discount levels at various points in time and across various retailers.

In embodiments the optimization application server 118 may include an Optimizing Subsystem that analyzes a “demand database” to determine optimal prices for retail goods and/or services. Where demand data is scarce, the price and discount optimizing subsystem can, in some embodiments, extrapolate from demand data for related goods. The Optimization Subsystem may be used to optimize various objectives including wholesaler or retailer profit, wholesaler or retailer market-share, effectiveness of advertising campaigns, and/or or the profit of the operator of a system as described herein. In embodiments, the Optimizing Subsystem can be used in stand-alone mode or integrated with the price exploration subsystem.

Also in embodiments the optimization application server 118 may include a Price Exploration Subsystem that analyzes the demand database to decide how to price inventory so as to simultaneously learn optimal prices and minimize loss in revenues due to price exploration or discounts. Embodiments of the Price Exploration Subsystem may include logic that is based on consumer and commodity clustering and can be augmented by standard machine learning and collaborative filtering algorithms. The Price Exploration Subsystem may be used in parallel with the participating retailer pricing service and/or the non-participating retailer discount subsystem.

The web application server 114 may include a Pricing Service that provides a web API for wholesalers and/or retailers to integrate prices generated by the price exploration and optimization subsystems into retailers' online storefronts. In addition, it provides mechanisms for wholesales and retailers to input their internal business pricing rules which constrain the pricing results generated by the system. In embodiments, the wholesalers and retailers may operate the remote server 108 and the web API may provide an interface between the web application server 114 and the remote server 108. In some embodiments, the Pricing Service receives inputs (Direct Demand Data, global item catalog updates, and Rights Holder/Retailer customer pricing rules), performs calculations, and exports price changes.

The application displaying the virtual storefront 104 and the web application server 114 may include a Non-participating Retailer Pricing Overlay Subsystem that includes three interoperating subsystems: a rebate Toolbar, a redemption center website, and an advertiser center. The rebate Toolbar, which can be installed (e.g., as a web browser plug-in) by consumers into the application displaying the virtual storefront 104, enables the consumers to view discounted prices, make purchases at such prices, and track discounts (in the form of rebates) for purchases made from selected participating and non-participating retailers. The functionalities and processes embodied by the Toolbar can also be delivered to users' computers via alternate means including applications manifesting different form factors and user experience characteristics. In any case, embodiments of rebates can be redeemed by consumers for goods, services, or cash at the redemption center. In some embodiments, rebates are determined from a combination of the Price Exploration Subsystem and auctions taking place in the Advertiser Center involving marketers who compete for the privilege to provide such consumer discounts.

The application displaying the virtual storefront 104 may include a Rebate Toolbar Subsystem that enables consumers to view discounted prices, make purchases at such prices, and track discounts (in the form of rebates) for purchases made from selected participating and non-participating retailers.

Displayed by the remote computer 102 in response to communications from the web application server 114 may be a Redemption Center Subsystem that, in embodiments, is a website allowing consumers to redeem accumulated discounts earned via the rebate toolbar for goods, services, or cash. One component of the redemption center subsystem is an integrated Virtual Storefront that approximates the experience provided by the rebate toolbar subsystem without requiring consumers to visit non-participating retailers or install the rebate toolbar application.

The business application server 120 may include an Advertiser Center Subsystem having a network-based user interface (such as a web page or the like). In embodiments, the network-based user interface of the Advertiser Center Subsystem is provided to an advertiser using a web browser or network application at the remote computer 102. That web browser or network application communicates with the web application server 114, which itself communicates with the business application server 120. In any case, the advertiser center subsystem allows potential advertisers to bid for the privilege of providing direct benefit (discounts/rebates) to consumers. Through the advertiser center, an advertiser can target particular consumer demographics or provide discounts for particular goods or kinds of goods. Advertisers specify their ad campaigns through a rich web-based bidding language and the advertising center can be directed to optimize the campaigns for both maximum consumer impact (to the benefit of Advertisers) and maximum profitability of the operator of the system as described herein.

Similarly, the business application server 120 operating in conjunction with the web application server 114 may enable a Rights Holder Dashboard providing an interface to Pricing Rules that govern an interaction between Rights Holders (including Aggregators) and the system 100. The Rights Holder Dashboard may include a network-based user interface (such as a web page or the like). In some embodiments, this network-based user interface is provided to an advertiser using a web browser or network application at the remote computer 102. That web browser or network application communicates with the web application server 114, which itself communicates with the business application server 120.

Via the Rights Holder Dashboard, a Rights Holder may review its catalog. Such review is available, for example, in logical groupings such as (in the case of Music) Artist, Album, Song Title, ISRC, Year of Release, Genre, and the like. Rights Holders may also apply Pricing Rules (or constraints) via the Rights Holder Dashboard by first running a query to select the affected items and then, by means of a form-based input method, design the particular constraints. Rights Holders may also have the capacity to indicate the agreed upon revenue share percentage of each sale that is to be retained by the participating Retailer. This is referred to as the “Distribution Fee.” The Rights Holder may input Distribution Fee percentages by viewing a list of all Retailers that are using the System (“Participating Retailers”) or query for a particular Retailer in order to edit a previously entered value. Lastly, a system of Alerts flag incomplete records and other items which require attention prior to being made Active.

In a manner analogous to the Rights Holder dashboard and the Advertiser Center Subsystem as described hereinabove, the business application server 120 operating in conjunction with the web application server 114 may enable a Retailer Dashboard and Pricing Rules where interaction between Retailers and the System takes place. The Retailer Dashboard allows Retailers to load into the System their cost basis for each Rights Holder content provider as well as to apply the appropriate mark-up of Distribution Fee percentages. Instead of querying for items, Retailers may query for Rights Holders. Through the Retailer Dashboard, the Retailer can look up Rights Holders by Name, Mark-Up %, Distribution Fee %, and Mode (Free Standing or Integrated as will be explained more fully below). Alerts indicate incomplete records and other items which require attention prior to being made Active.

In the data store 112, a Catalog Database may contain items for sale or discount via the system 100. Such items may be eligible for pricing optimization. In some embodiments, the Catalog Database is populated by a combination of dynamic cataloging that takes place as part of the demand data aggregation process and updated databases together with relevant metadata provided by third parties. Catalog item identifiers may include a combination of producer catalog identifiers, retail item identifiers and or global identifiers such as, in the case of recorded music, the ISRC (International Standard Recording Code).

Also in the data store 112, an Activity Database may store the direct demand and POS activity data aggregated for each item and correlate it with many variables such as Media Type, Channel Type (e.g. Website, Mobile), Currency, Territory, Relevant Pricing Rules, Most Recent Pricing Calculations, Quantity Available and Media Sub-Type (e.g. differences between products such as bit rate quality, added value enhancements such as Lyrics, and whether the item has DRM or is DRM-Free, and the like).

The data store 112 may also store, Point of Sale (POS) Sales data that is streamed into the system 100 from the remote server 108 of each of the Retailer partners (aka POS Partners). In embodiments, the POS sales data include, for every sale occurring during the reporting period, i) the identity of the item, ii) the price for which it sold, iii) the value of the overall transaction that included sale of the item, iv) a date/time stamp of the sale, and v) a non-identifiable user ID of the purchaser.

The business application server 120 or web application server 114 may include a Report Generator that builds reports of pricing and item information for each participating Retailer and/or Rights Holder. These reports may include current pricing that can be used for batch synchronization with third party systems or historical pricing trends to demonstrate the value and performance of the system. Each report has the ability to be retrieved manually via the management dashboard or scheduled for regular delivery via settings in the management dashboard.

Some embodiments of system 100 provide substantially real-time output via the web application server 114. This output may consist of revenue-optimizing end-user prices customized for each item (e.g. a single item) and sales channel consistent with the broad pricing strategies of each individual Rights Holder and Retailer.

Some embodiments of the web application server 114 include a web services interface that provides an API for third parties. Through this interface, the third parties can automate the retrieval of individual track information and adjust settings triggered by events in their own remote servers 108.

Further details of the aforementioned Subsystems may be appreciated in view of the following example, which is provided for the purpose of illustration and not limitation. The remainder of the discussion of FIG. 1 is dedicated to said non-limiting example.

In view of the foregoing it should be appreciated that some embodiments of the system 100 may include:
1. A Browser and Application Toolbar Plug-In (“Toolbar” or “DYMPOL Toolbar”)
2. Price Alerts System for accelerated price testing and advertiser sponsorship
3. Advertiser Bidding Marketplace
4. Auction Application for hyper-testing of priority items
5. Price/Discount Testing Algorithms
6. Redemption Center and Virtual Storefront website

A user installs the Toolbar and navigates to an enabled site (a website for which the Toolbar has been configured to extract data). The user logs in to the enabled site as usual, and is visually presented with alternate price points along with special Discounted Buy Buttons for the various products displayed on the Retailer's page that have been selected for testing and/or advertising sponsorship.

The Toolbar may scrape data from the displayed retailer HTML pages in order to identify what content is being displayed, what products are being sold and at what price. Then the toolbar may communicate with central servers in order to identify which price points should be explored or exploited, and/or which discount amounts will benefit advertising campaigns and the profitability of the operator of a system as described herein.

In another embodiment, a user navigates to the Virtual Storefront, the user logs in and is visually presented with an array of products with alternate price points that have been selected by the system based on price testing requirements, the user's demographic profile and the configuration of advertiser campaigns currently running on the subsystem. Users are also presented with buy buttons. In advance of each such user visit, the subsystem accesses data to identify the retail price and other metadata pertaining to the presented products and identifies which price points should be explored or exploited, and/or which discount amounts will benefit advertising campaigns and the profitability of the operator of the system as described herein.

In both cases, a specialized, self-learning price/discount testing algorithm operates in tandem with the results of advertiser auctions to determine the discounted prices to be displayed. These discounted prices are selected based on a variety of criteria, in a manner that performs at least one of the following functions:
1. Comprehensively test all viable demand curve points for a particular item or group of items;
2. Assign users to control and other differentiated testing groups;
3. Achieve specific promotional and advertiser brand marketing goals;
4. Determine prices that will maximize wholesaler revenue and/or;
5. Determine discounts that will maximize the effectiveness of advertising campaigns and the profitability of the operator of the system as described herein.

In order to provide reliable results and prevent user gaming of the system, once a price for a particular item is offered (by being displayed on the user's screen), that user's price for the item(s) in question does not change for a period of time. Such period of time may be predetermined, for example based on parameters entered into the system's administrative dashboard by a system operator, and/or dynamically based on real time system events.

When a user with the toolbar installed clicks on a Discounted Buy Button on a Retailer site, the transaction on the Retailer's site is executed as if the user had clicked on the Retailer's buy button and the user is presented with the identity and messaging of the advertiser or third party associated with the discount. Simultaneously, the difference between the Retailer's published price and the Discounted Price (also referred to herein as the “DYMPOL Price”) is noted and credited, as a rebate, to an account associated with the user.

In order to establish a comprehensive collection of demand data and purchase decisions and to explicitly establish a control group, the system registers all purchase clicks made by the user on enabled non-participating retailer sites regardless of which buy button (Retailer or Discounted) is clicked.

Similarly, when a user clicks on a buy button on a Virtual Storefront, the transaction request is referred to and fulfilled by a preferred third party Retailer that is integrated into the visible area of the Virtual Storefront. In such cases, the transaction is also executed as if the user had clicked on the Retailer's buy button and the user is presented with the identity and messaging of the advertiser or third party associated with the discount. Simultaneously, the difference between the Retailer's published price and the DYMPOL Price is noted and credited, as a pending rebate, to an account associated with the user.

Thus in some embodiments, the system as described herein provides a B2B Price Optimization System that dynamically delivers revenue-optimized point-of-sale pricing to Rights Holders (e.g. artists, record labels, studios, publishers and independent content producers) and interactive retailers for a broad array of digital products (e.g. Music, eBooks, Videos, Games, etc.) that have unlimited (digital) inventories.

Both Rights Holders and participating retailers are able to constrain the prices calculated by a Pricing Engine of the system as described herein by specifying their various businesses and pricing rules. In some embodiments, the Pricing Engine runs asynchronously within the optimization application server 118 or the business application server 120, generating prices for each item and Retailer based on a defined set of inputs. These inputs might include item information, historical sales data, and Retailer and Rights Holder settings, for example defined by the requirements of the pricing algorithms.

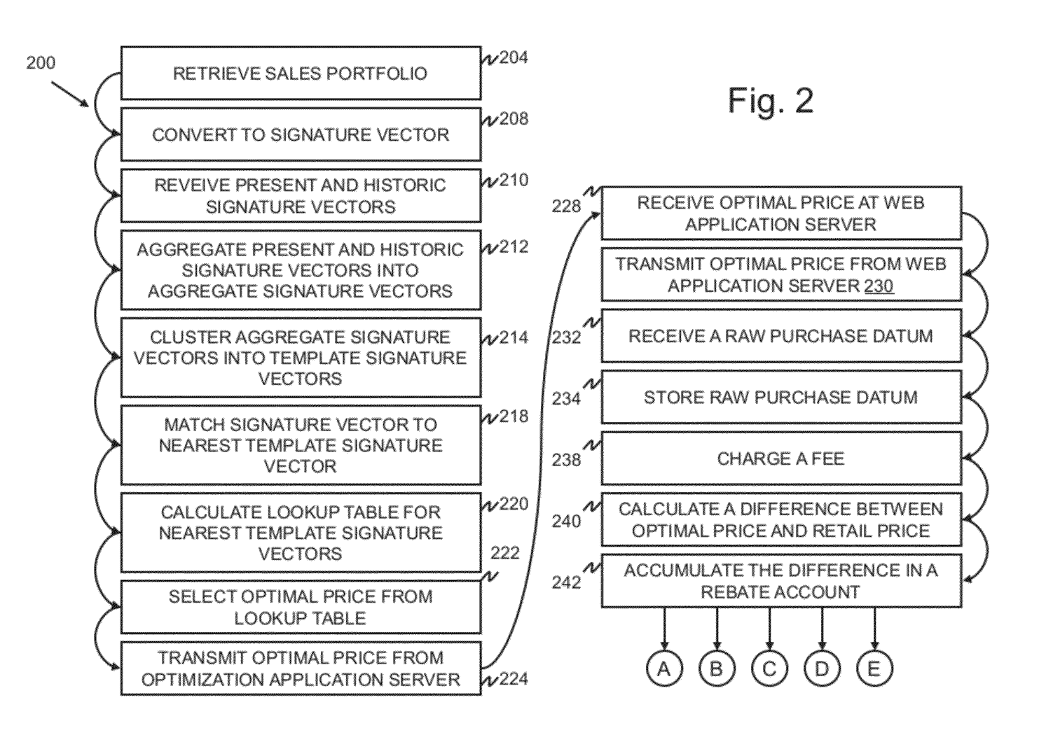

FIG. 2 depicts a method for value-based pricing. The method 200 includes a variety of steps which are first described briefly, and then described in varying levels of detail in the discussion that follows.

Beginning with step 204, the process may retrieve a sales portfolio for an item from the data store 112. The sales portfolio may include a plurality of raw purchase data about the item.

At step 208, the process may convert the sales portfolio for the item into signature vectors that represent sales performance of the item in a variety of market sectors, correlated against a variety of market, product and user variables and attributes. In order to dynamically determine which of these variables and attributes form a relevant basis for identifying items of similar prevailing elasticity of demand, the process may include ongoing testing of connecting patterns such as clusters of user profile characteristics (e.g., gender, age, geography, tested and untested item preferences, price sensitivity, social network attributes, and so on) and tested item metadata (e.g., genre, age of release, popularity/sales rankings, artist activity level such as frequency of releases and/or performances, and so on).

At step 210, the process may retrieve present and historic signature vectors from the data store 112.

At step 212, the process may aggregate the present and historic signature vectors into aggregate signature vectors.

At step 214, the process may cluster the aggregate signature vectors into template signature vectors that represent statistically different item types.

At step 218, the process may match the signature vector of the item to the nearest one of the template signature vectors.

At step 220, the process may calculate a lookup take for the nearest one of the template signature vectors.

At step 222, the process may select an optimal price for the item from the lookup table.

At step 224, the process may transmit the optimal price for the item to the web application server 114.

At step 228, the web application server 114 may receive the optimal price for the item.

At step 230, the web application server 114 may transmit the optimal price for the item to the application displaying the virtual storefront 104, via a first network connection.

At step 232, the web application server 114 may receive, from a second network connection to the application displaying the virtual storefront 104, a raw purchase datum indicating a purchase of the item by a user.

At step 234, the data store 112 may receive and store the raw purchase datum.

At step 238, the business application server 120 may calculate a difference between the optimal price for the item and a retail price for the item.

At step 240, the business application server 120 may accumulate the difference in a rebate account of the user.

With respect to step 220, the lookup table may be computed via experimentation on a subset of all items aggregated over time. It should be appreciated that the experimentation may be conducted on users, via the application displaying the virtual storefront 104. To support this, data related to the experimentation (such as and without limitation experimental prices, discounts, promotions, and the like, on the one hand; and user's purchase behavior in response to such experimental prices and the like, on the other hand) may flow between the process and the application that displays the virtual storefront 104, through the web application server 114 and the data store 112.

Generally, it should be appreciated that any and all of the steps of the method 200 may themselves comprise any number of steps, which in embodiments may be carried out as largely independent processes. For example and without limitation, in step 220 the calculation of the lookup table may occur over a period of time, may involve any number of interactions with any number of consumers in regard to any number of items, and may be carried out asynchronously from the rest of the method 200.

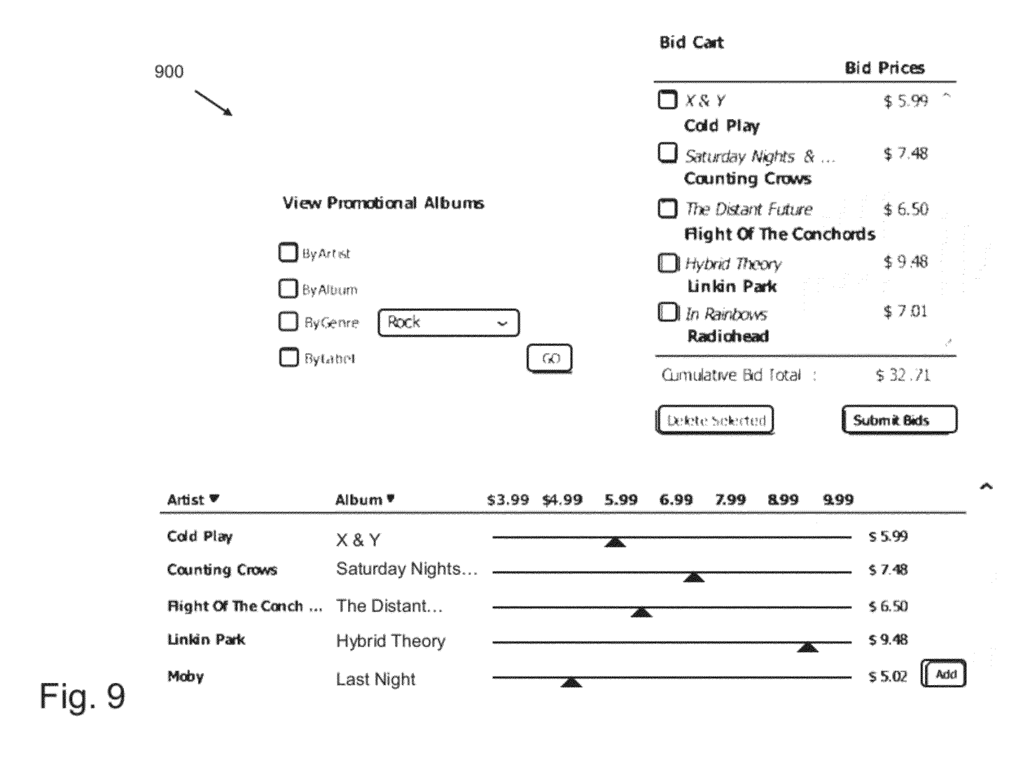

FIG. 2 and the method 200 may be further understood with reference to the following description, including descriptions of FIGS. 9-12, which is provided for the purpose of illustration and not limitation:

Another purpose of the application displaying the virtual storefront 104 (“Virtual Storefront”) is to funnel user traffic and attention to the featured SKUs presented there to explicitly solicit demand data for priority items. Priority items are defined as items for which accurate pricing results are needed but for which available demand data remains insufficient. The system's underlying algorithms are capable of dynamically determining which items require more testing and these automated determinations in combination with explicit item selections driven by business considerations populate the site's featured content pages.

As described previously, unlike the consumer experience using the Toolbar on third-party retail destinations, transactions taking place on the Virtual Storefront are not necessarily characterized by the display of both retail and discounted price points and buy buttons. Instead, either or both of two alternate approaches may be utilized: The first of these approaches involves the display of only the discounted buy button and a notation of the amount of the discount from the published price being offered. This results in a user experience that more closely resembles a traditional retail experience without the benefit of the Toolbar functionality described above. The second of these approaches is the use of auction price testing, as described in more detail below.

Auction Price Testing

An Auction Price Testing method may be employed, for example, when it is important to quickly acquire a comprehensive view of an entire demand curve for a particular set of items.

Referring now to FIG. 9, there is shown an example of a user interface for auction price testing according to one embodiment.

Rebate Liquidation and Second Degree Price Testing

In one embodiment, the Redemption Center Website provides users with the ability to withdraw their accumulated rebates in cash or to apply account balances to the purchase of advertisers' products and services.

This process enables the operator of the system as described herein to conduct second degree price testing. Utilizing the functions and algorithms already discussed, different price points are tested within the redemption center regarding consumer price sensitivity to advertisers' products and services. As with primary items, different users are offered different promotional price points and demand curves are drawn based on the observed purchase behavior.

Zero Regret Price Exploration

In decision theory, “regret” represents the difference between the actual benefit received consequent to taking a particular course of action and the benefit that would have been realized had a different course of action been chosen. In pricing theory, regret equals the loss of revenue sustained whenever a sub-optimal price is tested.

In embodiments, the system as described herein provides an approach for acquiring a direct stream of consumer demand data in order to test experimental prices in such a way that sellers (the producers or purveyors of content-based products and services) do not experience any revenue losses as a consequence of the testing process.

According to the techniques of the system as described herein, the difference between the predominant published retail price and the discounted test price offered by the system described herein is a liability borne by the operator of the system. Thus, sellers may gain the advantage of price testing without the associated regret. In addition, in one embodiment, the system as described herein employs a clustering approach to predictive modeling that minimizes the amount of testing that is required.

Price and Discount Optimization Algorithms and Clustering

With the consumer demand data aggregated as described above as an input, the system described herein is able to use proprietary algorithms in order to derive optimized prices and/or discounts as its output. The Optimized price is the price at which a given item, over a given period of time, will achieve maximum revenues. The Optimized discount is that discount at which the operator of the system as described herein, over a given period of time, maximizes profitability. Regardless of the output objective, the process of acquiring and analyzing input data is the same.

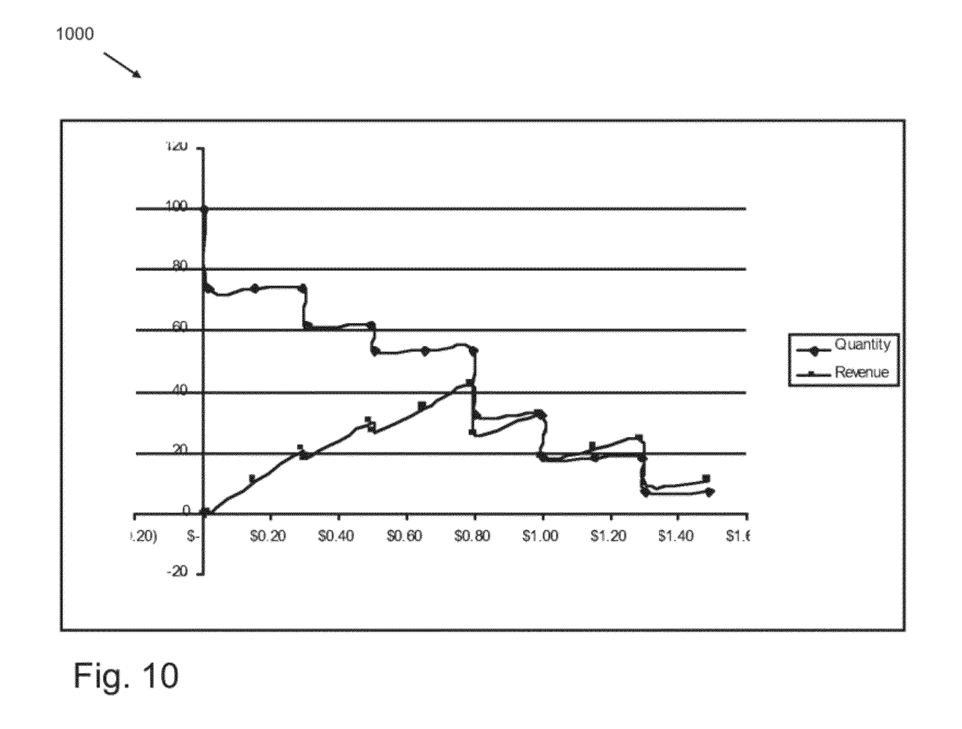

Given a comprehensive set of demand data (e.g. the number of people that would purchase a product at a given point in time for a specific price), the system described herein identifies the price that would optimize for (maximum) revenues. For instance, FIG. 10 depicts a process of identifying that the price point that corresponds to optimum revenue generation for the item shown is $0.79.

However, in real world situations, particularly those involving millions of items as is the case in digital content marketplaces, it is usually not possible to collect sufficient data to support the straightforward approach illustrated above. Consequently, in one embodiment the system as described herein utilizes one or more self-learning clustering algorithms that enable the correlation between items that are fully tested with those that are either not tested at all or not tested completely.

Price and Discount Optimization Using Clustering

In one embodiment, the system as described herein performs price and discount optimization by synthesizing sales data with low-cost and minimum-risk exploration techniques to determine on-the-fly regret-minimizing prices. Some features of this approach include: One price per item; Configurable price range and granularity; Minimal exploration of sub-optimal prices; Regret-minimizing introductory prices for new items; Immediately identified optimal prices for new items with no experimentation; Instantaneous price adjustments in response to market dynamics; and so on.

Embodiments of the system as described herein perform statistical extrapolation of an item's demand at all allowed prices from the item's market performance at a single given price. To achieve this extrapolation, the system as described herein converts an item's sales portfolio into a signature vector (or “signature”) representing the item's performance in different market sectors. Present and historic signatures are aggregated and clustered into template signatures representative of statistically different item types. In real-time, each item's sales signature is matched to the nearest template signature. The optimal price returned by the algorithm is the price that achieves maximum expected revenue for items with the same signature.

Exploration

Template signatures are learned on the fly from sales data. If an item's signature is unlike any template signature as determined using any suitable distance-based or other algorithm, a new template may be generated. A small percentage of items from each template are chosen at random to be pilot items; each is assigned an experimental price. This price is chosen from among all prices that might be the best price based on the performance of prior pilot items; plausible experimental prices are determined by a statistical comparison of the revenue achieved in prior experimentation.

The performance of pilot items at pilot prices is used to determine the expected demand curve for items of the template signature and thus the best price for all items that match the template signature. The cost of price exploration is minimized because only a small fraction of items are assigned an experimental price. After a few rounds of data collection, a template is identified for every distinct type of item; pilot items will have generated a statistically valid estimation of all template demand curves. As the system continues, it gathers more data and gains confidence in its predictions, allowing for a reduction in experimentation and continuous achievement of the maximum obtainable revenue.

Error Handling

In the event that two types of items behave identically across all market sectors at one price but drastically differently at other prices, the system is still able to identify an optimal price. In such a case, the optimal price is the price that minimizes expected regret, which depends on the relative frequencies of the two types. The system samples a representative proportion of the two types of item, so that the selected price will be the regret-minimizing price.

Data from this second price-point is automatically used to distinguish the two types of items (if possible) and thus identify the optimal price for future sales. Additional data, such as genre, artist, and past performance, is included in the clustering of items to reduce the likelihood of type/signature conflicts. This data is also used to provide regret-minimizing introductory prices for new items.

Market Sector Selection

For accurate pricing, it is preferable to utilize data from sufficiently distinct market sectors. In one embodiment, the system as described herein chooses sectors based on a combination of retailer and consumer demographics. More sophisticated market sectors can be determined by clustering consumers based on correlations in long-term item consumption data.

In embodiments, sector choice does not have to be perfect to achieve substantial revenue improvements. Furthermore, signatures can be computed from only a subset of potentially unrepresentative consumers. As long as market-wide performance data is available, the system will find optimal prices to the extent that behavior in the sampled market subset predicts market-wide behavior.

Performance Guarantees

The discounted price is the price that maximizes expected revenue based what can be inferred from available data. If the algorithm of the system as described herein chooses a sub-optimal price, it learns from market feedback that this price is not the correct price and does not choose it again.

Furthermore, discounted prices as generated by embodiments of the system as described herein are intrinsically dynamic, reflecting the statistically best price based on current market behavior. In one embodiment, past performance and other item data is used only to the extent that it improves the algorithm's ability to distinguish and thus price similarly performing items.

Demand Curve Clustering

In one embodiment, the system as described herein uses a Demand Curve Clustering approach, focused on the identification of a representative number of historical demand curve paths which are then grouped to form reference templates. A demand curve path is a sequence of optimized price points correlated for the amount of time an item has been publicly available in the marketplace. Over time, a finite number of active demand curve path templates (numbering in the tens to hundreds, for example) are identified and used as a reference to model a prediction of the expected demand curve paths of untested or insufficiently tested items.

The demand curve of a given item is a dynamic entity; accordingly, in one embodiment, the system as described herein continuously updates item categorization every time new sales data is acquired. When an item begins to gain market share, its type will likely change as will its optimized price. This dynamic process is aided by statistical information concerning demand curve evolution. In the same way that the system can make reasonable assumptions about a single demand curve from just a few data points (and statistical information about all demand curves), it can also anticipate the evolution of demand for a certain item using market cues and historic data from items of the same template type.

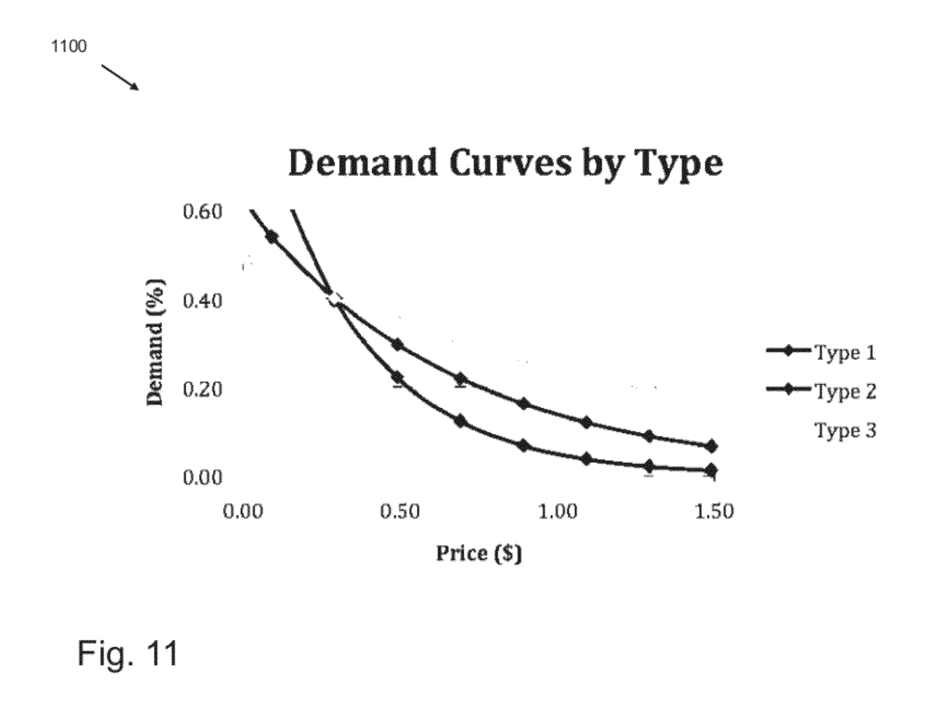

For example, suppose that demand curves for a set of items can be approximated by one of the three exponential curves in FIG. 11, and that these items all have roughly the same potential market size.

This categorization is based on the shape of the item's demand curve; subjective descriptions of these types are designed as after-the-fact reflection as to why different items might belong to each template type.

Type 1: 40% at $0.29, 1.8×decay per $0.20. Type 1 items are typically items by unknown, unadvertised producers/artists. They can be sold cheaply to consumers exploring such “long tail” content, but are otherwise of unknown quality and should not be offered for sale at higher prices.

Type 2: 40% at $0.29, 1.35×decay per $0.20. Typical Type 2 items are popular items in small niches or old classics that many consumers already own. While some consumers will pay a premium for these items, many more are interested at mid-range prices.

Type 3: 40% at $0.29, 1.15×decay per $0.20. Type 3 items are represented by hit content. Interested consumers will usually seek out these items and are willing to pay any reasonable cost. Notwithstanding the foregoing, it is expected that other hit content, depending on the price sensitivity of its core audience, may in fact be much more elastic than the Type 3 template described here.

Pricing a new item of unknown type at $0.69 reveals completely the item's type in a single sales period. The demands for Type 1, Type 2, and Type 3 items at $0.69 are 12%, 22%, and 30%, respectively. As long as enough sales data is acquired at the $0.69 price point, the chance of an item being incorrectly categorized is extremely limited. The amount of data required before categorization is a function of the 10% gap between demands for the three template types (used in this simplified example) and a user-specified tolerance for error.

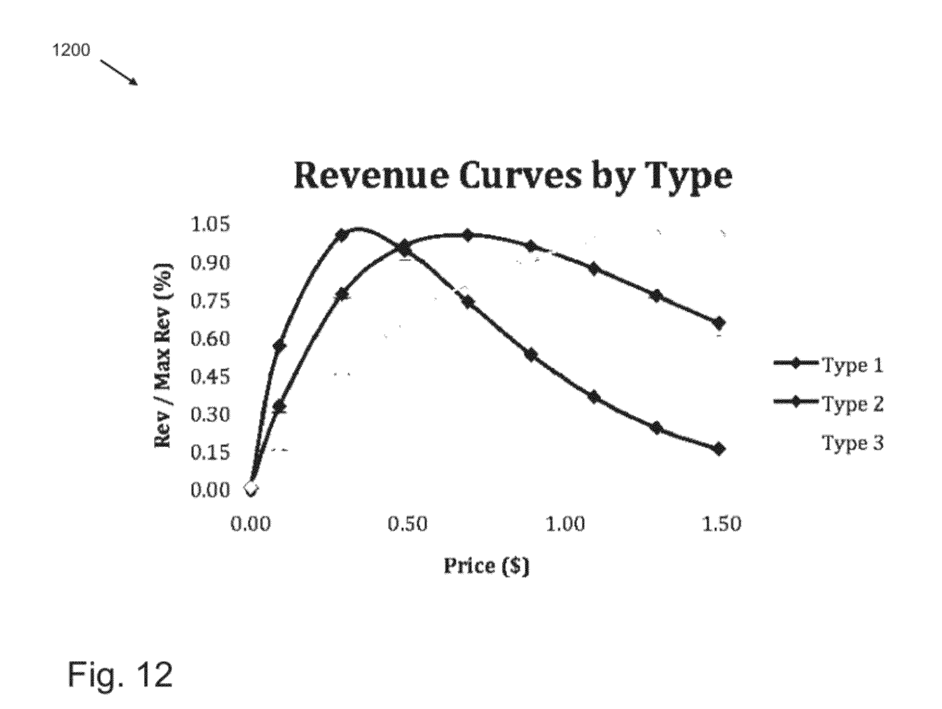

Once an item type is identified, the price can immediately be updated to the optimal price for that type. These optimal prices are determined by looking at the revenue curves in FIG. 12: $0.29 for Type 1 items, $0.69 for Type 2 items, and $1.49 for Type 3 items.

Even when embodiments of the system as described herein are not in the position to effectively deliver zero regret price testing, the cost of this exploration would be minimal because only a small fraction of items are sold at explorative prices. Consumers cannot game the system for the same reason, though occasionally a consumer might find an item they want at a bargain price.

Algorithm Description

Some embodiments include a pricing algorithm that proceeds as follows: 1. Market sectors specifications and prior purchase data are combined to generate a set of template signatures for every price. 2. Each item's recent purchase data is used to compute a single signature, which is matched to the nearest template signature corresponding to the appropriate price. 3. Each template has data on the performance of items with similar templates at every potential price (this data is generated by Step 4). The regret-minimizing price is selected as the price with the best overall performance as indicated by template data. 4. The performance of each item at its new price is averaged into the pre-existing template data to guarantee the accuracy of future prices. 5. Occasionally, an item is assigned an experimental price, thereby ensuring that data is collected at all prices for every template signature.

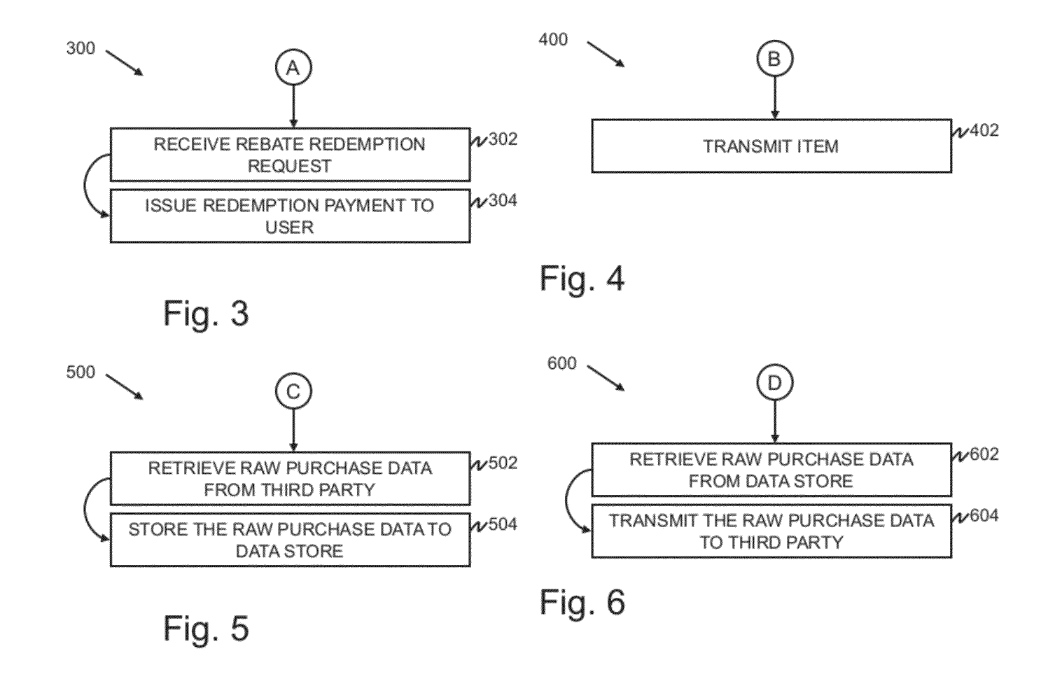

Referring now to FIG. 3, a method for value-based pricing in conjunction with issuing a rebate to a user 300 includes steps 302 and 304. At step 302, the web application server 114 receives, from a third network connection to an application on a remote computer 102, a rebate redemption request of the user. At step 304, the business application server 120 issues a redemption payment to a user by deducting an amount of the rebate redemption from the rebate account of the user.

Referring now to FIG. 4, a method 400 for value-based pricing in conjunction with selling and transmitting an item to a user 400 includes step 402. At step 402, the item transfer server 110 transmits the item to the remote computer 102.

Referring now to FIG. 5, a method 500 for value-based pricing in conjunction with supplemental, raw purchase data and passive media consumption data 500 includes steps 502 and 504. At step 502, the web application server 114 receives, from the remote server 108, a plurality of raw purchase data indicating sales by a third party. At step 504, the data store 112 receives and stores the plurality of raw purchase data.

Referring now to FIG. 6, a method for value-based pricing in conjunction with a multi-campaign marketing organization 600 includes steps 602 and 604. At step 602, the web application server 114 or the item transfer server 110 retrieves, from the data store 112, a plurality of raw purchase data. At step 604, the web application server 114 or the item transfer server 110 transmits the plurality of raw purchase data to the remote server 108.

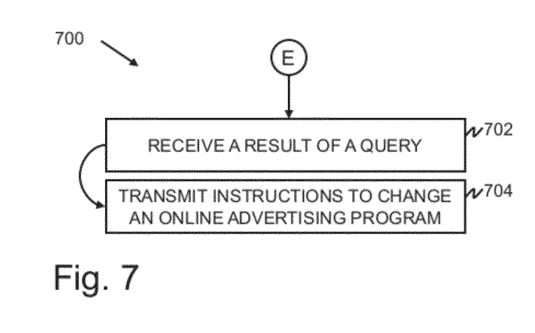

Referring now to FIG. 7, a method for value-based pricing in conjunction with a search-driven advertising network 700 includes steps 702 and 704. At step 702, the web application server 114 receives, from the remote server 108, a result of a query. At step 704, the web application server 114 transmits, to the remote server 108 and in response to the result of the query, instructions to change an online advertising program. For example and without limitation, the result of the query may indicate web search results or advertisements to be served alongside web search results and the instructions to change the online advertising program may indicate which of the advertisements to display, in which order to display the advertisements, which prices or discounts should be displayed in or with the advertisements, and so on. In some embodiments, the result of the query is the result of a continuous query, which returns results over time and as new information becomes available or searchable.

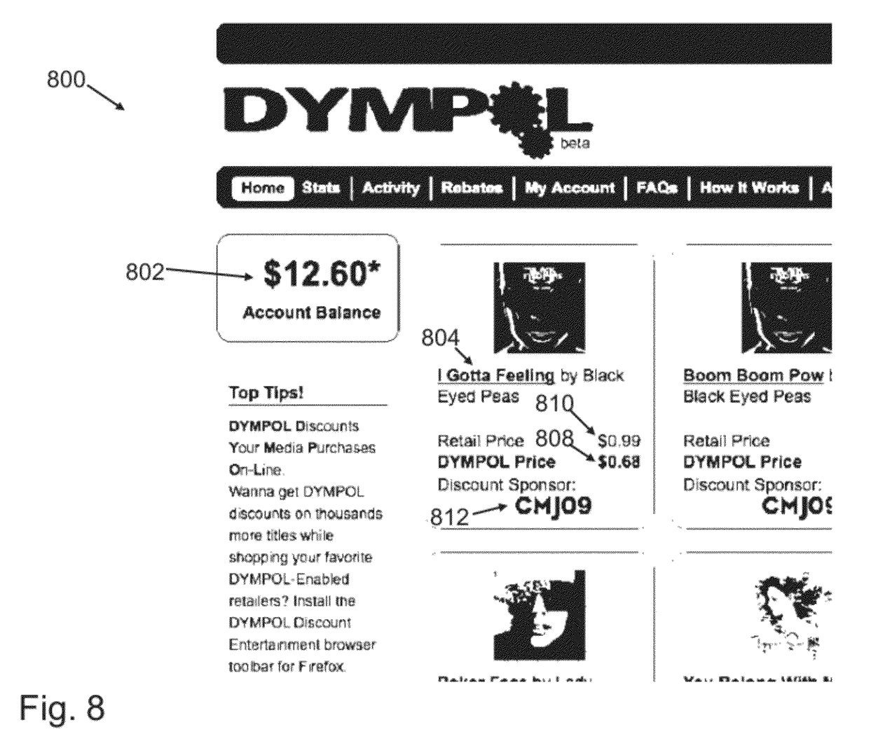

FIG. 8 depicts a user interface for value-based pricing in conjunction with brand promotion 800. The user interface includes a depiction of a balance in a rebate account of a user 802; a depiction of an item for sale 804; a depiction of a retail price of the item for sale 808; a depiction of a discount price of the item for sale 810; and a depiction of a brand icon of marketer 812 that is sponsoring the discount price.

The foregoing systems and methods may be usefully integrated with advertising and/or sponsorship systems in any of a variety of ways. For example, a content provider (which may be, e.g., a record label, a retail media sales channel, and individual artist, a broadcast network, and so forth) may advantageously improve total revenue by selling content through an appropriately enabled web site. By selling content through a platform that determines an optimal price and automatically (or manually) rebates a difference between the optimal price and a nominal retail price to a purchaser, the aggregate revenue for the content may be improved. At the same time, revenue may be further enhanced by the content provider or an operator of the platform by selling sponsorship of these rebates on a product-by-product, retailer-by-retailer, or other basis. Sale of sponsorships may occur, for example, in an automated or semi-automated manner using an online auction system, or manually through a sponsorship interface that permits a user to specify particular sponsorships and any number of parameters for same (specific content, types of content, time periods, etc.). The sponsorship interface may support hosted communications between sponsors and content providers who may manually agree on a price, or the sponsorship interface may support an auction or other virtual marketplace for transactions between content providers and sponsors.

It will be appreciated that a wide variety of sponsorship pricing and revenue models may be suitably employed to allocate sponsorship revenue between a content provider, a content purchaser (who receives a rebate), and a platform provider. It will further be appreciated that sponsorship may take a wide variety of forms including advertising, discounts for sponsored goods or services, loyalty rewards, and so forth.

Thus in one aspect there is disclosed herein a method including identifying an item of digital content from a content provider, the digital content having a retail price; determining an optimal price for the digital content; selling a sponsorship of the digital content to a sponsor for a differential price based upon a difference between the retail price and the optimal price; offering the item of digital content for sale at the retail price, with a rebate equal to the difference between the retail price and the optimal price; and upon a sale of the digital content to a purchaser, collecting the differential price from the sponsor, and returning the rebate to the purchaser.

The method may include returning the optimal price to the retailer. The method may also or instead include returning a portion of the differential price to the retailer, which the retailer may use to support the rebate or to achieve a net price closer to the retail price for the digital content.

According to an embodiment of the present invention, the system and methods described herein may be utilized as a performance-based (or direct-response) cause marketing platform that connects brands to Influencers and their fans. The system may be configured to deliver measurable engagement by linking advertisers directly to music, sports and entertainment fans. In a preferred embodiment of the present invention, the system may be configured to identify one or more optimal charitable sectors for a particular advertiser. For instance, a home improvement store may be optimally paired with charities that are associated with their related goods or services, such as Habitat for Humanity. In this manner, consumers are inclined to associate the advertiser with related charities and the advertiser stands to benefit the most from the associated good will from the charity. Through these features, a new and novel method for raising money for charity is provided, in that the method described herein leverages advertiser campaigns that run on the basis of advertiser self-interest to result in raising money for charity.

As detailed above, the system may utilize signature vectors to monitor, determine and analyze performance of an advertiser, in this case, in a particular charitable sector. The system as described herein is configured to convert an advertiser's portfolio into a signature vector (or “signature”) representing the advertisers performance in different charitable sectors. Present and historic signatures are aggregated and clustered into template signatures representative of statistically different advertiser types. In real-time, each advertiser's signature is matched to the nearest template signature. The optimal charitable sector returned by the algorithm is the charitable sector that achieves maximum expected synergy with the same signature.

According to an embodiment of the present invention, once the optimal charitable sector is determined, the system may identify one or more Influencers that support one or more organizations in that charitable sector to potentially associate with the advertiser. Alternatively, an advertiser can select specific Influencers they wish to partner with, or be matched to one or more Influencers, based on specified criteria with or without regard to association to the optimal charitable sector. Influencers are individuals, groups or other entities that have particular notoriety in one or more public arenas or otherwise have notability to the general public for one or more reasons. In an exemplary embodiment, Influencers include, but are not limited to, bands, singers, athletes, sports teams, celebrities, performers, actors, models, famous individuals, politicians and other notable figures. One of ordinary skill in the art would appreciate that there are numerous types of Influencers that may be utilized with embodiments of the present invention, and embodiments of the present invention are contemplated for use with any type of Influencer.

Advantageously, Influencers attract fans to the advertiser. In accordance with embodiments of the system, when fans give to Influencer endorsed causes, they get advertiser rewards. Rewards may include, but are not limited to, coupons, discounts, gift cards, promotional items, free merchandise and reward points. One of ordinary skill in the art would appreciate that there are numerous types of rewards that could be utilized with embodiments of the present invention, and embodiments of the present invention are contemplated for use with any type of reward.

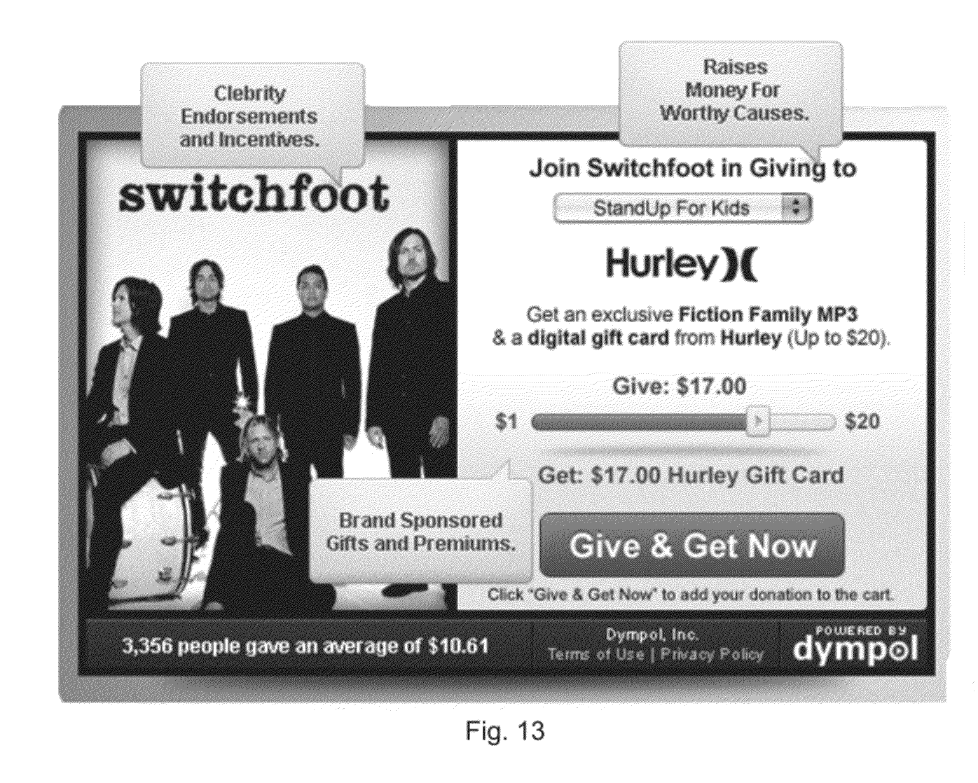

According to an embodiment of the present invention, the system may be configured to use one or more user interfaces that allow dynamic correlation between donation amount and reward type and amount. As the user increases their donation, the reward received from the advertiser and/or Influencer may also increase or change. An exemplary embodiment of this can be seen in FIG. 13. These user interfaces (“Charitable Advertisement Units” or “CHAUs”) enable advertisers to create custom, rich media advertisement units infused with functionality allowing for donations to be made in conjunction with rewards to be received from the advertiser/Influencer(s) (“Charitable Checkout”). Advertisers can serve in the roles of both Influencer and sponsor, or import existing celebrity instances. In a preferred embodiment, donations may comprise donations denominated in fiat currencies. In other embodiments, donations may comprise donations of any kind, including but not limited to, donations of time, goods, services or any combination thereof. One of ordinary skill in the art would appreciate that there are numerous types of donations that may be utilized with embodiments of the present invention and embodiments of the present invention are contemplated for use with any type of donation.

According to embodiments of the present invention, the system may be configured to provide or distribute CHAUs via third-party advertisement networks (e.g., Google, Yahoo!, Commission Junction, DoubleClick) and social networks (e.g., Facebook, MySpace, Xanga, Linkedln). In an exemplary embodiment, the system may be configured to distribute these CHAUs through Application Programming Interfaces (APIs) provided by the various advertisement networks and social networks. In other embodiments, the distribution of CHAUs may be effected through APIs provided directly by the system or indirectly through other third-parties. One of ordinary skill in the art would appreciate that there are numerous methods for providing/distributing CHAUs over established networks, and embodiments of the present invention are contemplated for use with any method for providing/distributing CHAUs.

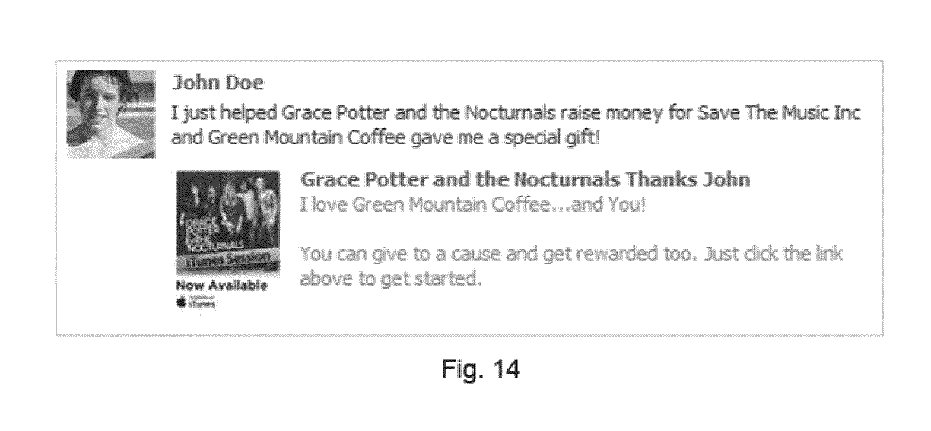

According to an embodiment of the present invention, users who make donations to the charities or causes associated with the Influencers that are linked to particular advertisers may be provided with public notifications (i.e., “Social Thanks”) made by their heroes (i.e., Influencers) on social networks or other communication methods/devices (e.g., SMS, text messages, personalized voicemail). In this manner, the advertiser and charity may benefit from the friends/family/contacts of the user, as these individuals will potentially see the public notification received by the user from the Influencer and make a similar donation to a charity associated with the Influencer and make a purchase from the advertiser. FIG. 14 shows an exemplary embodiment of a “Social Thanks”

Social Thanks may be automated responses based on specific donation amounts, personalized responses from the Influencer, or any combination thereof. For instance, an automated social thanks may be made to all individuals who donate <$100, while personalized social thanks may be provided to all users who donate >$100. In a preferred embodiment of the present invention, all Social Thanks are provided dynamically. In this manner, the social thanks are always customized based on variables related to the transaction and such criteria can trigger second-degree customization (e.g., different social thanks at specific donation thresholds).

According to an embodiment of the present invention, the system may be configured to be integrated with e-commerce checkouts, social networks, regular web sites, in mobile applications that enable event-based activation, and/or into existing display and performance interactive advertising networks.

According to an embodiment of the present invention, the system is configured to utilize proprietary matching technology to assure that advertisers are attached to appropriate Influencer channels in terms of both relevancy and business rules. The system may be configured to match advertisers to appropriate Influencers and charitable sectors based on bidirectional campaign criteria. For example, an advertiser who wants to reach fans of a particular class of Influencers (e.g., Category=Sports, Type=Team, Genre=Baseball, and Status=Championship Winner) would be provided with Influencers with those characteristics. Influencers and advertisers may also blacklist certain characteristics, traits or other criteria, or to name industry exclusives, so that they are only associated with appropriate counterparties. For instance, an Influencer may choose to blacklist advertisers of certain types (e.g., Industry=Tobacco, Wines & Spirits) and/or name an industry exclusive (e.g., If Industry=Sportswear, Then Industry Exclusive=Under Armor). One of ordinary skill in the art would appreciate that there are numerous criteria that may be utilized to appropriately blacklist or target specific characteristics for Influencers and advertisers and charitable sectors, and embodiments of the present invention are contemplated for use with any criteria.

It is an object of an embodiment of the present invention to provide advertisers the ability to be matched with Influencers and/or optimal charitable sectors. In this manner, the system may be configured to identify an optimal charitable sector for an advertiser based on one or more criteria associated with the advertiser, criteria associated with Influencers and a potential Influencer that would be compatible with the particular optimal charitable sector. Criteria associated with an Influencer include the category of Influencer (e.g., music, sports, theatrical, literary, etc.), type of Influencer (e.g., musician, band, team, athlete, actor, etc.), demographics (e.g., age, gender, etc. of Influencer and Influencer's audience). One of ordinary skill in the art would appreciate that there are numerous types of Influencer criteria that may be utilized with embodiments of the present invention, and embodiments of the present invention are contemplated for use with any type of Influencer criteria. Criteria associated with the advertiser include, but is not limited to, industry, size, demographics and business strategies. One of ordinary skill in the art would appreciate that there are numerous types of advertiser criteria that may be utilized with embodiments of the present invention, and embodiments of the present invention are contemplated for use with any type of advertiser criteria. In alternate embodiments, the Influencer may select a particular advertiser and allow the system to identify an optimal charitable sector that exists between the Influencer and the particular advertiser.

As previously described, the system is configured to use historical and statistical data in order to optimize the association of charitable sectors, Influencers and advertisers. In certain embodiments, advertisers may choose to be associated with groups of Influencers and the system may be configured to utilize the methods described herein to identify and associate the advertiser with multiple Influencers and charities in a particular charitable sector to broaden the advantages described herein. In this manner, advertisers may utilize the data generated and identified through the use of the systems and methods described herein to provide testing of consumer brand preferences, in the context of making charitable donations, and associating with consumer affinity group (e.g., fans of heavy metal love. Brand X) via multiple sponsor selection.

In one embodiment, the system described herein may provide consumers the ability to send electronic charitable giving greeting cards. In such embodiments, the system is configured to allow the consumer to send the charitable giving greeting card with either the sending consumer serving as the Influencer, or selecting from a repository of existing celebrity instances. The greeting card donation is prepaid by the sending consumer, and the recipient determines which charity receives the donation. In certain embodiments, the charities may be limited to those pre-selected by the sending consumer, those associated with the selected celebrity Influencer or any combination thereof. In other embodiments, the recipient may choose any charity. The system may also provide the sending consumer the ability to select one or more advertisers to populate the greeting card and both sender and recipient receive the advertiser coupon/reward associated with the prepaid donation. If a Social Thanks is available for such a donation, the Social Thanks may be given to the sending consumer, the recipient or any combination thereof.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While particular embodiments of the system as described herein have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A web-based system that enables advertisers to participate in charitable giving campaigns while significantly tying cost to measurable performance, the system comprising:
a data store that stores an advertising portfolio for an advertiser,
wherein the advertising portfolio includes a plurality of data regarding the advertiser,
wherein said plurality of data regarding the advertiser includes present and historic signature vectors;
an optimization application server operatively coupled to the data store;
a web application server operatively coupled to both the optimization application server and the data store;
a business application server operatively coupled to the data store;
a first memory in the optimization application server, the first memory containing computer-executable code that, when processed by the optimization application server, performs steps comprising:
converting the advertiser portfolio for the advertiser into a signature vector that represents performance of the advertiser in a variety of charitable sectors;
aggregating the present and historic signature vectors into aggregate signature vectors;
clustering the aggregate signature vectors into template signature vectors that represent statistically different advertising types;
matching the signature vector of the advertiser to the nearest one of the template signature vectors;
calculating a lookup table for the nearest one of the template signature vectors, the lookup table computed via experimentation on a subset of all advertisers aggregated over time;
selecting an optimal charitable sector from the lookup table; and
transmitting the optimal charitable sector for the advertiser to a web application server; a second memory in the web application server,
the second memory containing computer-executable code that, when processed by the web application server, performs steps comprising:
receiving the optimal charitable sector for the advertiser from the optimization application server;
transmitting, to an application displaying a virtual interface at a remote computer, an association between the advertiser and a charity selected from the optimal charitable sector;
receiving, from the application displaying the virtual interface at the remote computer, a donation datum indicating a donation made by a user; and
storing, to the data store, the donation datum; a third memory in the business application server,
the third memory containing computer-executable code that, when processed by the business application server, performs steps comprising:
calculating a reward to be provided from the advertiser to the user for the donation; and
distributing said reward to the user.

2. The web-based system of claim 1, wherein the application displaying the virtual interface at the remote computer includes a web browser plug-in.

3. The web-based system of claim 1, wherein the business application server is the web application server.

4. The web-based system of claim 1, wherein the third memory containing computer-executable code is further configured to perform the step of transmitting, to the remote computer, the reward.

5. The web-based system of claim 1, wherein a fourth memory containing computer-executable code is further configured to perform the steps of:
receiving, from a remote server, a plurality of raw data indicating relevant information regarding the advertiser; and
storing, to the data store, the plurality of raw data.

6. The web-based system of claim 1, wherein a fourth memory containing computer-executable code is further configured to perform the steps of:
retrieving, from the data store, a plurality of raw advertising data; and
transmitting, to a remote server, the plurality of raw advertising data.

7. The web-based system of claim 1, wherein a fourth memory containing computer-executable code is further configured to perform the steps of:
receiving, from a remote server, a result of a query; and
transmitting, to the remote server, in response to the result of the query, instructions to change an online advertising program.

8. The computer-implemented method of claim 8, wherein the result of the query is a result of a continuous query.

9. A web-based method that enables advertisers to participate in charitable giving campaigns while significantly tying cost to measurable performance, the method comprising the steps of:
Storing, in a data store, an advertising portfolio for an advertiser, Wherein the data store is operatively coupled to an optimization application server;
wherein the advertising portfolio includes a plurality of data regarding the advertiser,
wherein said plurality of data regarding the advertiser includes present and historic signature vectors;
converting the advertiser portfolio for the advertiser into a signature vector that represents performance of the advertiser in a variety of charitable sectors;
aggregating the present and historic signature vectors into aggregate signature vectors;
clustering the aggregate signature vectors into template signature vectors that represent statistically different advertising types;
matching the signature vector of the advertiser to the nearest one of the template signature vectors;
calculating a lookup table for the nearest one of the template signature vectors, the lookup table computed via experimentation on a subset of all advertisers aggregated over time;
selecting an optimal charitable sector from the lookup table; and
transmitting the optimal charitable sector for the advertiser to a web application server;
receiving the optimal charitable sector for the advertiser from the optimization application server;
transmitting, to an application displaying a virtual interface at a remote computer, an association between the advertiser and a charity selected from the optimal charitable sector;
receiving, from the application displaying the virtual interface at the remote computer, a donation datum indicating a donation made by a user; and
storing, to the data store, the donation datum;
calculating a reward to be provided from the advertiser to the user for the donation; and
distributing said reward to the user.

10. The web-based method of claim 9, further comprising the steps of:
receiving, a reward redemption request of the user; and
issuing the reward to the user.

11. The web-based method of claim 9, further comprising the step of transmitting, to the remote computer, the reward.

12. The web-based method of claim 9, further comprising the steps of:
receiving, from a remote server, a plurality of raw data indicating relevant information regarding the advertiser; and
storing, to the data store, the plurality of raw data.

13. The web-based method of claim 9, further comprising the steps of:
retrieving, from the data store, a plurality of raw advertising data; and
transmitting, to a remote server, the plurality of raw advertising data.

14. The web-based method of claim 9, further comprising the steps of:
receiving, from a remote server, a result of a query; and
transmitting, to the remote server, in response to the result of the query, instructions to change an online advertising program.

15. The computer-implemented method of claim 9, wherein the result of the query is a result of a continuous query.

16. A web-based method comprising:
identifying an advertiser;
determining one or more of an optimal charitable sector for the advertiser and an Influencer;
associating said Influencer and said advertiser in an advertisement; and
transmitting said advertisement to a remote computer;
receiving, from said remote computer, a donation made by a user;
transmitting a reward to a reward account of said user, wherein said reward is based at least in part on the value of said donation.

17. The web-based method of claim 16 further comprising transmitting, to a social network, a communication associated with said Influencer regarding said donation from said user.

18. The web-based method of claim 17 wherein said communication associated with said Influencer is to be displayed on said social network and references said user and said donation.

19. The web-based method of claim 16, wherein said optimal charitable sector for said advertiser is selected, at least in part, based upon criteria identified by said advertiser in an advertising portfolio.

20. The web-based method of claim 16, wherein said Influencer is related to said optimal charitable sector.
